(19) United States
(12) Patent Application Publication
(10) Pub. No.: US 2016/0161027 A1
(43) Pub. Date: Jun. 9, 2016

(54) CASED PIPELINE NETWORK

(71) Applicant: Lorin Scott Lawson, Killdeer, ND (US)

(72) Inventor: Lorin Scott Lawson, Killdeer, ND (US)

(21) Appl. No.: 14/564,279

(22) Filed: Dec. 9, 2014

(51) Int. Cl. F16L 3/26; F16L 3/18; F16L 1/12; F16L 3/08; F16L 55/16; F16L 55/168

(52) U.S. Cl. CPC F16L 3/26; F16L 55/16; F16L 55/168; F16L 1/12; F16L 3/08; F16L 3/18

(57) ABSTRACT

Cased pipeline network enclosed by casing with the primary purpose of the casing for leakage containment and control. A high number of pipelines are arranged inside and enclosed by an outer casing. The outer casing functions to contain and control leaks and provides a safer means of transporting gas or liquid products across sensitive areas or underwater. The casing flows leaked gas or liquid products to the pipeline network terminals for collection. The pipeline network simplifies and consolidates the permitting and approval process by allowing for the development of a high number of pipelines as a single project. Individual pipelines within the network may be separately managed to carry different gas or liquid products.

### BACKGROUND OF THE INVENTION

During an oil boom, production of oil and gas typically leads the development of infrastructure necessary to transport those products. Development of pipelines is needed to keep up with production volume and ship products to market. Rail tanker cars and tank trucks may not be efficient modes of transportation depending on the geographic location. A highly efficient mode of transporting oil and gas is by pipeline. Pipeline infrastructure can be very effective for crossing large bodies of water and remote or inaccessible terrain.

Safely transporting gas or liquid products is a high concern to pipeline developers and owners. The detection and containment of leaks is therefore necessary. Leaks may be caused by separation of pipelines by mechanical forces, cracks in pipes or welding, defective couplings, or corrosion. Corrosion resistant alloy materials, chemical coatings or cathodic protection can protect against corrosion in cast iron or carbon steel pipelines. Production loss reports, electronic sensor systems, shutoff valves, and flow meters are available methods for detecting and containing leaks.

The development of new pipeline infrastructure involves a complex and time consuming process including, but not limited to, planning, surveying, engineering, and permitting by local and federal governmental agencies. It is necessary for the developer to acquire easements, right of ways, and mineral rights from private, state, and federal landowners. The development of a high number of pipelines as a single project is therefore an efficient method of building new infrastructure.

Pipeline bundles, bundled pipelines and pipe-in-pipe systems are well known methods for installing multiple pipelines with cost savings. The bundle is typically comprised of a carrier pipe with internal pipelines that may carry oil, gas, water as well as electrical cables or heating lines and insulation material. Pipeline bundle methods in the prior art comprise only a small number of internal pipelines and have been primarily designed to carry heating tubes or heating medium for solving the problem of temperature control and thermal insulation in cold underwater environments. However, pipeline bundles do not solve the problem of developing a high number of pipelines as a single project. Current bundle methods are limited to installing a small number of pipelines. There does not exist a pipeline bundle system or method that provides for a network of a high number of pipelines.

### BRIEF SUMMARY OF THE INVENTION

The present invention relates to a cased pipeline network and method comprised of a high number of pipelines enclosed within an outer casing. The primary function of the outer casing is for leakage containment and control. Leakage of oil or gas products from the interior pipeline network are contained by the outer casing and flowed to the pipeline network terminals for collection. Containment and control of leaks provides for a safer means of transporting underwater and through sensitive areas. Additionally, by combining a high number of pipelines within a casing, the permitting, approval and development of multiple pipelines may be undertaken as a single project. Furthermore, individual pipelines within the network may be leased or sold and separately managed to carry different oilfield related products. In summary, the present invention provides for a cased pipeline network for leakage containment; the development of a high number of pipelines as a single project; and a method for separate and diversified line management.

### BRIEF DESCRIPTION OF THE SEVERAL VIEWS OF THE DRAWING

FIG. 1 is a cross section of the cased pipeline network showing two carrier pipelines or conduit pipelines encasing a high number of interior pipelines flowing gas or liquid products, CO2, oil, saltwater, and natural gas.

FIG. 2 is a three-dimensional view of the cased pipeline network with two carrier pipelines or conduit pipelines encasing a high number of interior pipelines for flowing gas or liquid products.

FIG. 3 is a side-view of the cased pipeline network showing the carrier pipelines or conduit pipelines encasing a high number of interior pipelines.

FIG. 4 is a cross section of the cased pipeline network showing leakage containment by the outer casing or conduit pipeline or carrier pipeline enclosing a high number of interior pipelines for flowing gas or liquid products. Leakage is apparent by cracks in the interior pipelines and leaked gas and liquids are successfully contained and controlled by the outer casing.

FIG. 5 is a close-up view of leakage containment by the outer casing or conduit or carrier pipeline. Leaked gas and liquid products are successfully contained by the outer casing and the environment, body of water and wildlife outside the pipeline are protected.

FIG. 6 is a diagram showing the pipeline network crossing a large body of water with pipeline network terminals for accepting and delivering gas or liquid products.

FIG. 7 is a flow chart showing the development of a high number of pipelines as a single project and the separate and diversified management of pipelines within the network.

### DETAILED DESCRIPTION OF THE INVENTION

Described here is an pipeline network enclosed by an outer casing. The outer casing may be comprised of a containment pipeline or conduit pipeline or carrier pipeline. A high number of pipelines comprise the network and are located inside the casing. An embodiment of the pipeline network may comprise two to twenty (2-20) interior pipelines or line pipes enclosed by a 72-inch diameter outer casing. An alternative embodiment of the pipeline network may comprise two to twenty (2-20) interior pipelines or line pipes enclosed by a 60-inch diameter outer casing. Alternative embodiments of the invention may comprise different numbers of interior pipelines or line pipes enclosed by an outer casing of a diameter appropriately fitted to the network of interior pipelines. For example, an alternative embodiment of the pipeline network may comprise twelve (12) total interior pipelines enclosed by a 60-inch diameter outer casing or carrier pipeline with the interior pipelines comprised of eight (8) 12-inch line pipes, two (2) 10-inch line pipes, and two (2) 8-inch line pipes. Another embodiment of the pipeline network may comprise seven (7) total interior pipelines enclosed by a 60-inch diameter outer casing or carrier pipeline or conduit pipeline with the interior pipelines comprised of one (1) 20-inch line pipe, four (4) 14-inch line pipes, and two (2) 16-inch line pipes. Another alternative embodiment of the pipeline network may comprise nineteen (19) total interior pipelines enclosed by a 72-inch diameter outer casing or carrier pipeline or conduit pipeline with the interior pipelines comprised of nineteen (19) 8-inch line pipes.

Interior pipeline diameters are determined by design requirements for fluid or gas flow and operating pressure. The interior pipelines may be embodied by 8-inch, 10-inch, 12-inch, 14-inch, 16-inch or 20-inch diameter line pipes. Alternative embodiments of the interior pipelines may comprise different sized diameter line pipes. Pipeline wall thickness is determined by a function of the maximum operating pressure, pipeline diameter, material grade, and industry design codes and regulations. Interior pipelines and the outer casing may be constructed with seamless or welded pipeline sections comprised of high-strength carbon steel line pipe of Grade A, Grade B, or stronger grades X42 through X80. Corrosion resistant alloy materials and anti-corrosive coatings may be used for protecting the interior pipelines and outer casing. Pipeline and casing sections may be assembled by arc welding, annealing to avoid cracks in welds, and the use of mechanical couplings or fittings. Hyperbaric welding may be used to weld pipeline sections underwater as well as to repair fractures and leaks.

A steel spacer or polymer spacer may align and space the interior pipelines within the casing. The spacer may be embodied by a circular steel plate mounted by welding inside the casing or conduit or carrier pipeline with circular holes for supporting and arranging the interior pipelines within the casing. The circular holes in the spacer may be lined with ball bearings or rollers to reduce friction while inserting and installing the interior pipelines. An embodiment of the spacer may comprise a 60-inch diameter circular disk shaped steel plate with seven (7) total holes, the holes comprising a 20-inch hole, two 16-inch holes, and four 14-inch holes, with the holes appropriately sized to support 20-inch, 16-inch and 14-inch diameter lines pipes respectively. Alternative embodiments of the spacer may comprise different combinations of appropriately sized holes. For example, an alternative embodiment of the spacer may comprise a 60-inch diameter circular disk shaped steel plate with twelve (12) total holes, the holes comprising eight (8) 12-inch holes, two (2) 10-inch holes, and two (2) 8-inch holes, with the holes appropriately sized to support 12-inch, 10-inch and 8-inch diameter line pipes respectively. Another alternative embodiment of the of the spacer may comprise a 72-inch diameter circular disk shaped steel plate with nineteen (19) total holes, the holes comprising nineteen (19) 8-inch holes for supporting 8-inch diameter line pipes. Alternative embodiments of the spacer may comprise different sized diameter circular disk shaped steel plates, appropriately sized to fit the inside diameter of the conduit or carrier pipelines, with the spacer comprising different sized diameter holes to fit a variety of different sized diameter line pipes. The thickness of the spacer shall be such that the pipelines are evenly supported within the casing. A thicker or longer spacer will allow the distance between spacers to be greater, whereas a thinner spacer shall require a shorter distance between spacers. The spacer material may be carbon steel, corrosion resistant alloy, or polymer. Pressure monitors, electronic sensor systems, shutoff valves, flow sensor or meters, shutdown systems, check valves, shut-off valves, gas compressors and pumps may be located along the pipeline network to measure and control flow and pressure. Remote monitoring and control of pumps, compressors, valves and metering may be used to centrally manage the pipeline network.

The pipeline network may be embodied by one or more underwater conduits or carrier pipelines running in parallel to cross a large body of water several miles long. The conduit or carrier pipelines enclose of a high number of pipelines within an outer casing. A high number of pipelines may be aligned and welded into place within the outer casing with assembly being completed on shore. For on shore sections of the pipeline route, the pipeline network may be put underground and lowered into a trench and then covered with soil or other overburden. For underwater sections crossing bodies of water, lakes, rivers, or streams, the pipeline route is dredged beforehand, then the fully assembled pipeline network may be floated off shore, towed or pulled across a body of water, aligned into position and then submerged. Back-filing, burying, rock dumping and concrete coating and filling may be employed to provide minimum cover for pipeline protection and anchoring. Alternatively, the pipeline network may be assembled into place by joining and welding together multiple prefabricated 1,000-foot sections of pipeline and casing assemblies. In another embodiment, the casing or conduit pipeline may be installed first and then the interior pipelines may be threaded though. Ball bearing or rollers installed along the circumference of the spacer holes of the pipeline spacer assemblies will help to reduce friction and allow the interior pipelines to be easily threaded though the spacers during assembly. The use of a large conduit or carrier pipeline allows a high number of pipelines to be installed and developed as a single, consolidated project.

An embodiment of the present invention may comprise one or more 72-inch conduit or carrier pipelines made of carbon steel with a corrosion resistant coating. Another embodiment of the present invention may comprise one or more 60-inch conduit or carrier pipelines comprised of carbon steel with a corrosion resistant coating. Alternative embodiments of the pipeline network may comprise differently sized diameter conduit or carrier pipelines and different numbers of conduit or carrier pipelines with each having different numbers of interior line pipes. For example, an alternative embodiment of the pipeline network may comprise two (2) 60-inch diameter conduit or carrier pipelines with each conduit containing twelve (12) total interior line pipes. Another embodiment of the pipeline network may comprise two (2) 60-inch diameter conduit or carrier pipelines with each conduit containing seven (7) total interior line pipes. Another embodiment of the pipeline network may comprise two (2) 72-inch diameter conduit or carrier pipelines with each conduit containing nineteen (19) total interior lines pipes. Another alternative embodiment of the pipeline network may comprise two (2) 60-inch diameter conduit pipelines or carrier pipelines with each conduit containing two to twenty (2-20) interior pipelines or line pipes. Another alternative embodiment of the pipeline network may comprise two (2) 72-inch diameter conduit pipelines or carrier pipelines with each conduit containing two to twenty (2-20) interior pipelines or line pipes. Corrosion protection may be accomplished through the use of epoxy coatings, tar-enamel coatings, asphalt coatings, and polyethylene or polypropylene coatings. The one or more conduit or carrier pipelines are aligned in parallel to traverse a large body of water by running along a lake bed or sea floor. Each conduit or carrier pipeline may include 2-20 interior carbon steel pipelines that make up the pipeline network. The interior pipelines are enclosed within a leak-proof casing. The casing may be comprised of a 60-inch or 72-inch carbon steel conduit or carrier pipeline. Different sized casing may used for different applications involving varying numbers and sizes of interior line pipes. With two to twenty (2-20) interior pipelines in each parallel conduit, the pipeline network embodied in two conduits comprises a sum total of four to forty (4-40) individual pipelines. Alternative embodiments may comprise different numbers of interior pipelines and an appropriately sized diameter casing, conduit, or carrier pipeline to enclose the interior pipeline network. The interior pipelines may be utilized to carry oil, natural gas, carbon dioxide, waste-water, saltwater, water, or other gas or liquid products. Leakage of any of these gas or liquid products is contained within the casing and protected from contaminating the land or water along the pipeline route and corridor.

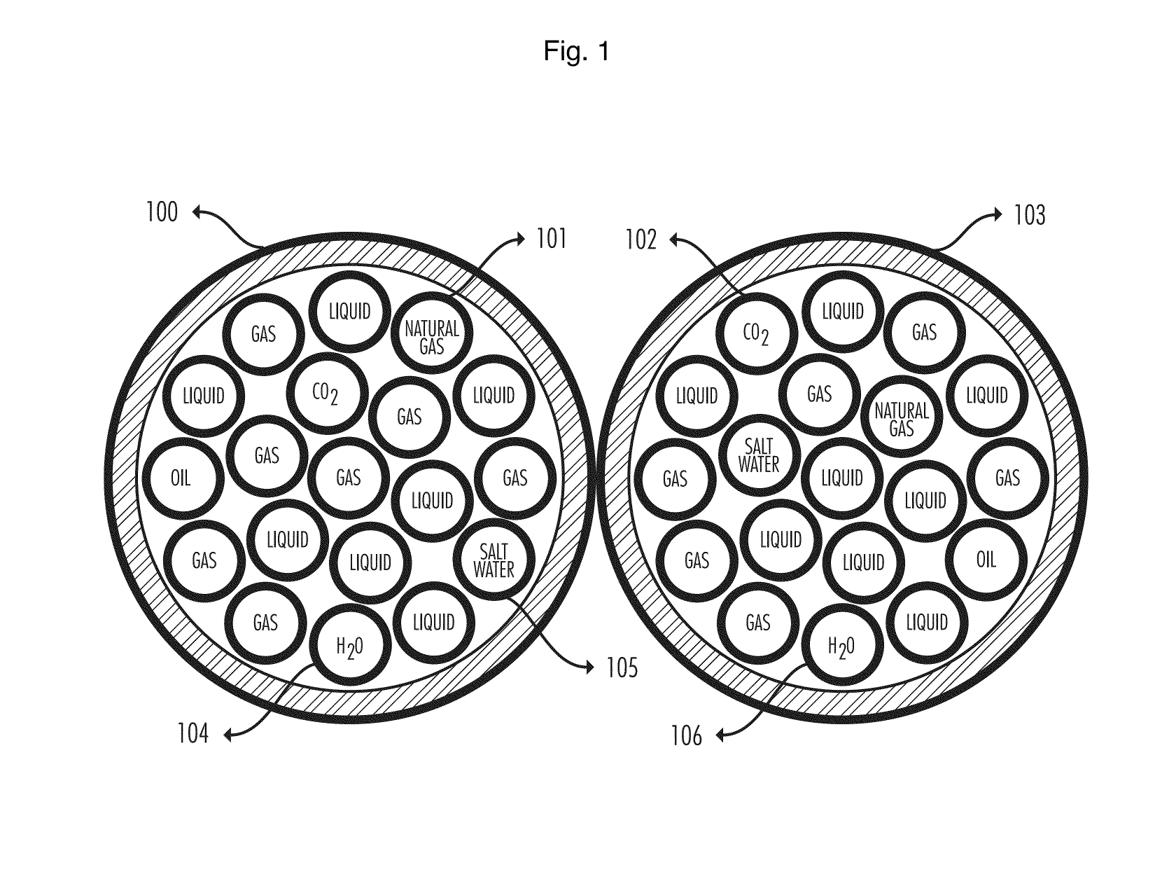

FIG. 1 shows a cross section of two (2) conduit pipelines or carrier pipelines encasing a high number of interior pipelines for flowing gas or liquid products. In the drawing as shown, the conduit or carrier pipelines 100 and 103 enclose nineteen (19) interior pipelines 101, 102, 104, 105, 106. With two conduit pipelines 100 and 103, as shown in FIG. 1, the pipeline network comprises thirty-eight (38) total individual interior pipelines or line pipes. The pipeline network in FIG. 1 flows natural gas 101, CO2 or carbon dioxide 102, water or H2O 104 and 106, salt water 105, and other gas or liquid products. Leakage of gas or liquid products is contained and controlled by the outer casing 100 and 103.

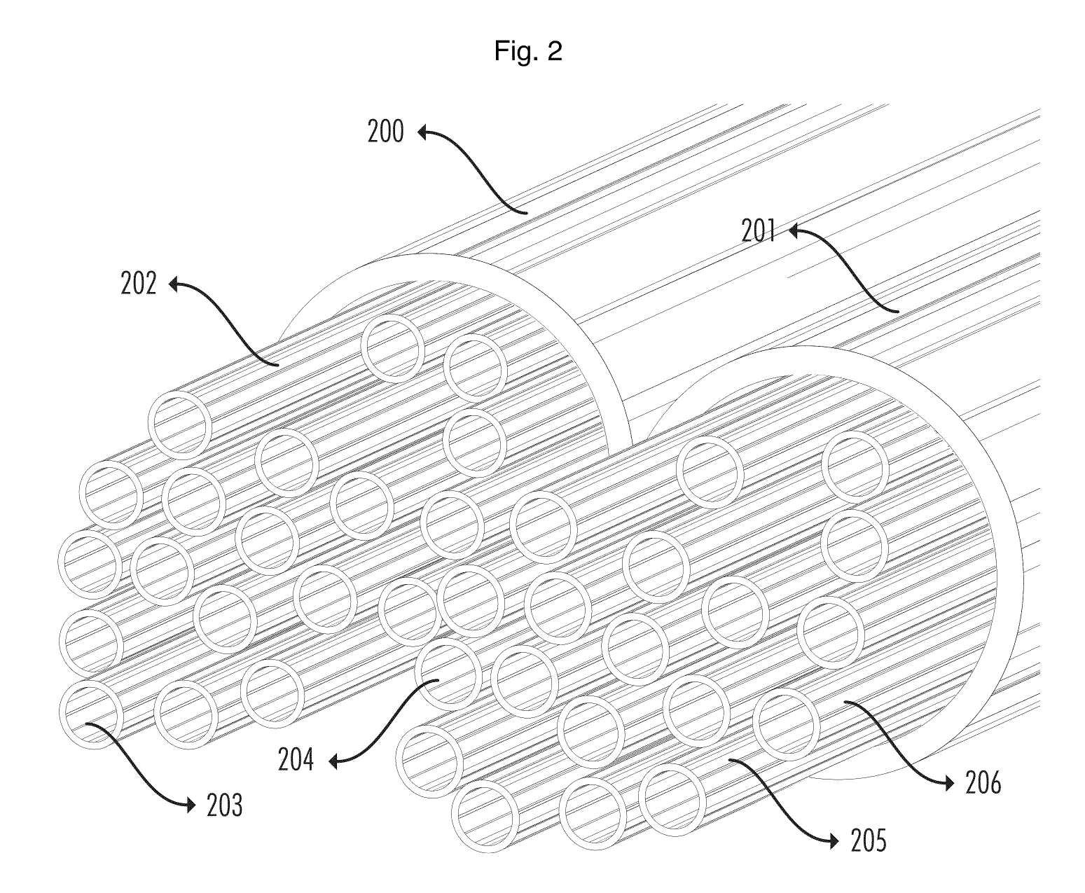

FIG. 2 is a three-dimensional view of two (2) conduit pipelines or carrier pipelines encasing a high number of interior pipelines for flowing gas or liquid products. The conduit or carrier pipelines 200 and 201 each enclose nineteen (19) individual interior pipelines 202, 203, 204, 205, and 206. In total, the dual conduits 200 and 201 comprise a pipeline network of thirty-eight (38) individual interior pipelines as shown in the drawing. Leakage of gas or liquid products is contained and controlled by the outer casing 200 and 201.

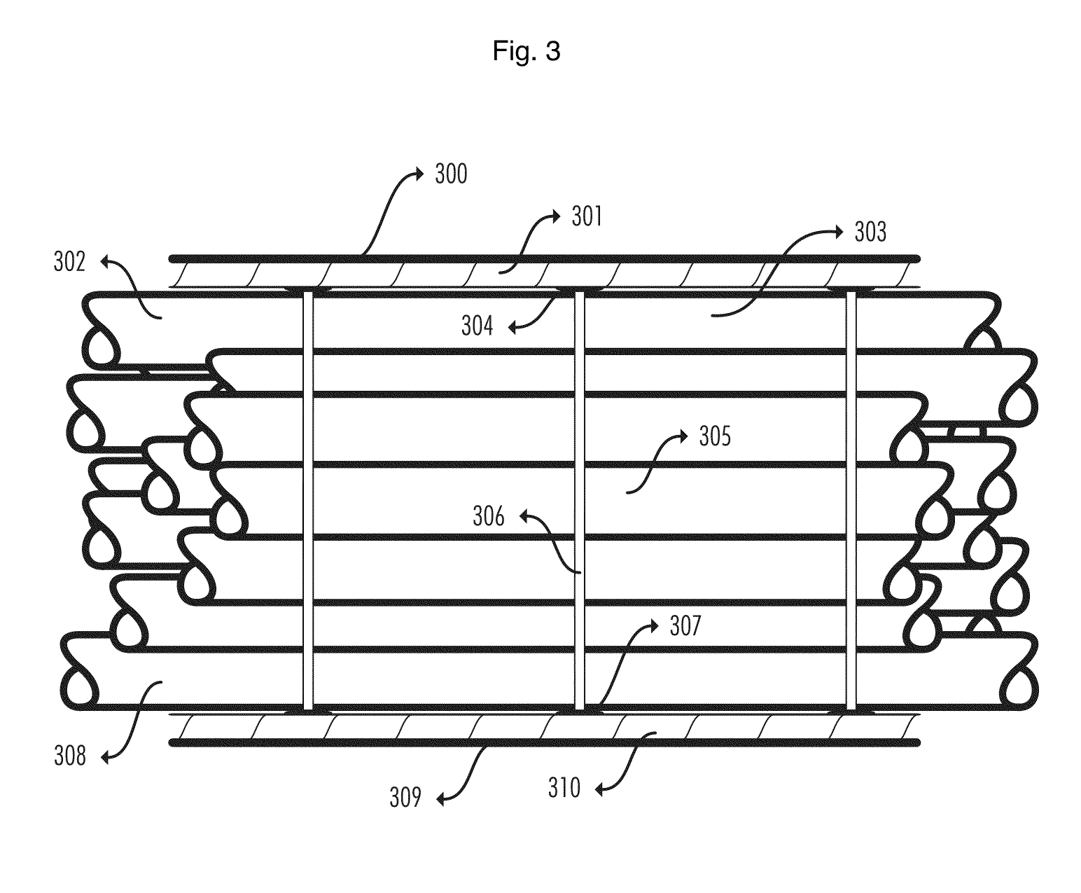

FIG. 3 is a side-view of the cased pipeline network showing a single conduit or carrier pipeline containing a high number or interior line pipes. The conduit or carrier pipeline 300, 301, 309, and 310 encloses a high number of interior pipelines 302, 303, 305 and 308 for flowing gas or liquid products. This embodiment of the pipeline network has twelve (12) interior line pipes. The spacer 306 aligns and supports the interior line pipes with the conduit or carrier pipeline 301, 310. The spacer 306 is mounted inside the conduit or carrier pipeline 301, 310 by welding or other means at 304 and 307. Leakage of gas or liquid products is contained and controlled by the outer casing 300, 301, 309 and 310.

Pipeline routing and corridor design is a function of the specific location of the pipeline network with consideration for the geographic location. For example, a proposed pipeline route from point A to B may have special considerations for sensitive areas, parks, watersheds, farmland, environment, wildlife, historic sites, unique geography, landscape, and bodies of water. The pipeline route and corridor width may be mapped with aerial photography, satellite images, SONAR or LiDAR. The body of water or lake bed may be dredged beforehand to provide a clear and stable foundation for laying the pipeline network and underwater conduit or carrier pipelines. Overburden or other material may be added to secure and protect the pipeline network. Soil erosion control and measures to minimizing landslides may be conducted during and after pipeline construction. Sections of the pipeline network may reside above ground, below ground, underwater or above the water as the pipeline network traverses along the planned route and corridor. The pipeline network may have terminals located at either ends for accepting or delivering gas or liquid products. Electric pumps and gas compressors are located along the pipeline network to transport gas and liquid products along the route and maintain operating pressures and flow rates. For transporting liquids, the hydraulic power, flow rate and operating pressure will determine the size, spacing and number of electric pumps required. For gases, the flow rate, temperature, and compression ratio will determine compressor capacity and locations. Typically a larger diameter pipeline and a higher number of pumps or compressors are required for transporting gases than liquids.

The pipeline network may carry crude oil, high-pressure natural gas, or carbon dioxide at operating pressures of 1,480 PSI (pounds per square inch) or higher or lower pressures depending on flow rates for different products. Other gas or liquid products, including but not limited to ethane, anhydrous ammonia, liquefied natural gas (LNG), gas condensate, liquefied hydrocarbons, water, saltwater, or waste-water may be carried at different operating pressures and flow rates.

Over time due to corrosion, weathering, thermal expansion and contraction, lateral buckling and upheaval, weld fracture, or fatigue, the pipeline network may develop leaks. To solve this problem and provide additional environmental protection, leakage from the interior pipelines is contained within and controlled by the outer casing, conduit pipeline, or carrier pipeline. Leaked gas or liquid products are captured by the outer casing and prevented from escaping into the environment. The leaked gas or liquids are contained and controlled by the casing and flowed through the conduit or carrier pipeline and away from sensitive areas of land or bodies of water. Leaked products may be flowed in the pipeline network via sump pumps, valves, or gravity flow. Leaked gas or liquid product are collected at the pipeline network terminals. Leaked gas or liquid products may also be collected at pooling points along the pipeline network with small diameter collector pipelines developed for pumping or flowing leaked products. An embodiment of the collector pipeline may be a 1-2 inch diameter pipeline used for collecting the leaked gas or liquid at the pooling point. The outer casing cannot absolutely prevent leaks but otherwise functions to improve containment and successfully control leaks. Structural strength, mechanical protection, and corrosion resistance are secondary benefits to the casing.

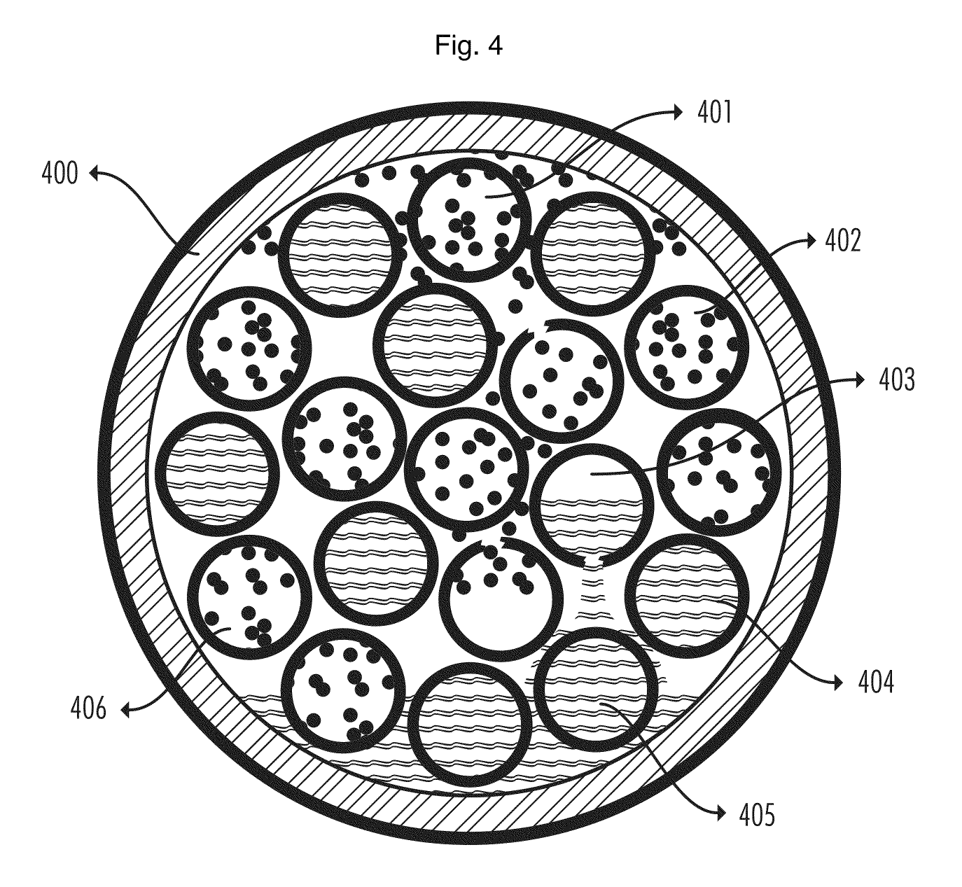

FIG. 4 is a cross section of the cased pipeline network showing leakage containment by the outer casing or conduit pipeline or carrier pipeline 400 enclosing a high number of interior pipelines 401, 402, 403, 404, 405, 406 for flowing gas or liquid products. Leakage is apparent by cracks in the interior pipeline 403. Leaked gas and liquids have escaped from the compromised interior pipelines and have filled the inside of the pipeline network. Looking closely, leaked liquid products have collected and pooled around pipeline 405 and leaked gas products have collected and pooled around pipeline 401. However, the leaked gas and liquids are successfully contained and controlled by the outer casing 400.

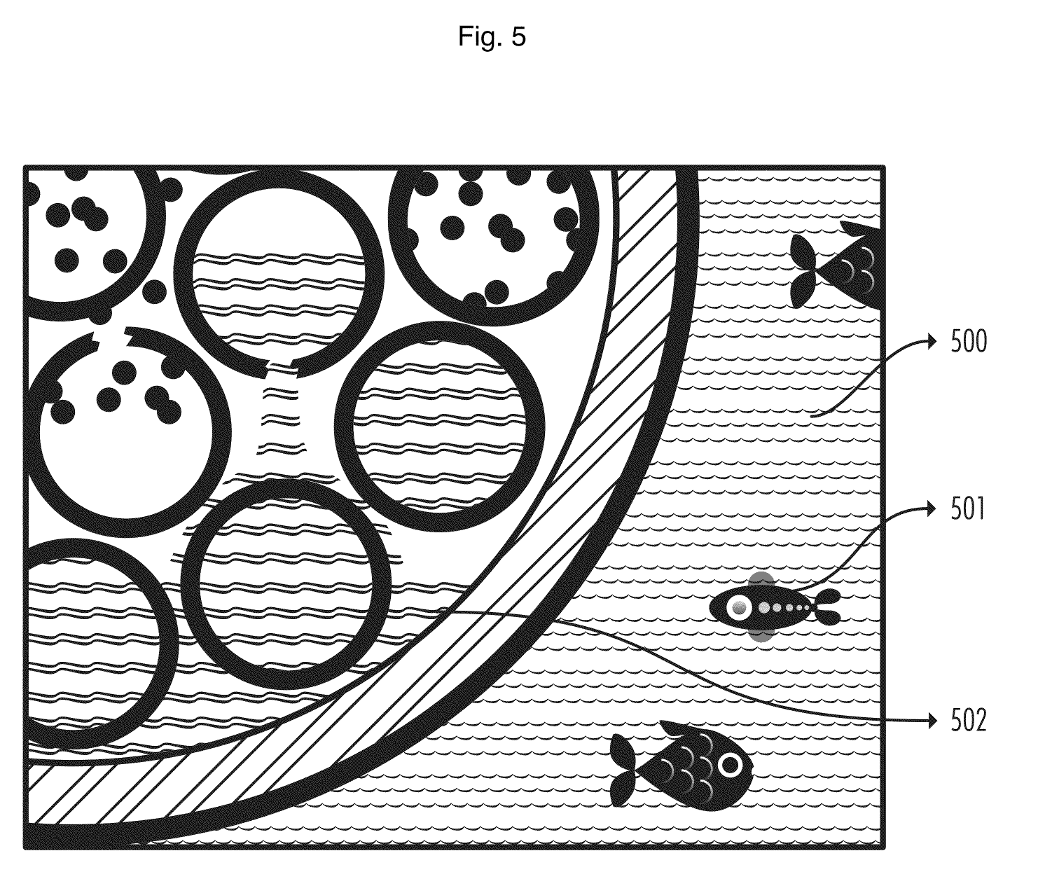

FIG. 5 is a close-up view of leakage containment by the outer casing 502. Leaks in the interior line pipes are apparent as liquid products have pooled and collected at the bottom of the casing or conduit pipeline. Also, gas products have escaped in cracks in the interior line pipes and have entered the space between the line pipes and the casing or conduit pipeline. However, the leaked gas and liquid products have been successfully contained and controlled by the casing or conduit pipeline 502. The environment surrounding the pipeline network is protected by the outer casing or carrier pipeline or conduit pipeline 502. The body of water 500 and wildlife 501 are protected from contamination by the outer casing 502.

In an embodiment of the present invention, a small pinhole leak due to corrosion may develop in an interior crude oil pipeline in the pipeline network. The leak may occur in a section of the pipeline network that is miles away from shore and 50 feet underwater and therefore difficult to access and service. The crude oil leaks from the interior pipeline, but is otherwise contained within the outer casing and within the pipeline network. The casing prevents the leakage from contaminating the body of water and environment outside the pipeline network. The leaked crude oil is contained by the casing and flowed through the conduit pipeline away from the leak site and to an eventual collection point. Pumps or gravity flow may be used to flow the leaked crude oil. The leakage is collected at the pipeline network terminals located at the end of the network and in an area more accessible for pumping and removing the leaked crude oil.

In another embodiment of the present invention, a natural gas leak may arise due to thermal expansion and contraction along the pipeline network. The natural gas leak may be discovered by a detectable pressure drop in an interior pipeline in the pipeline network. Because natural gas is colorless, the exact location of the leak may be very difficult to locate. The outer casing prevents the leaked natural gas from escaping and contains the gas within the pipeline network. A dangerous natural gas leak situation is averted with the containment and control of the leak. The leaked natural gas product is flowed through the casing and collected at the pipeline network terminals.

In another embodiment of the present invention, an interior pipeline in the network used to carry saltwater or hydraulic fracturing waste-water may develop a leak due to the highly corrosive nature of saltwater. The waste-water leak may be discovered through production loss reports at the pipeline network terminals. The leakage is safely contained within the outer casing and kept within the pipeline network. Animal wildlife, crops, plants, vegetation, and drinking water sources are protected by containing the waste-water leak within the pipeline network casing. The outer casing flows the waste-water away from sensitive land areas and bodies of water to the pipeline network terminals for collection.

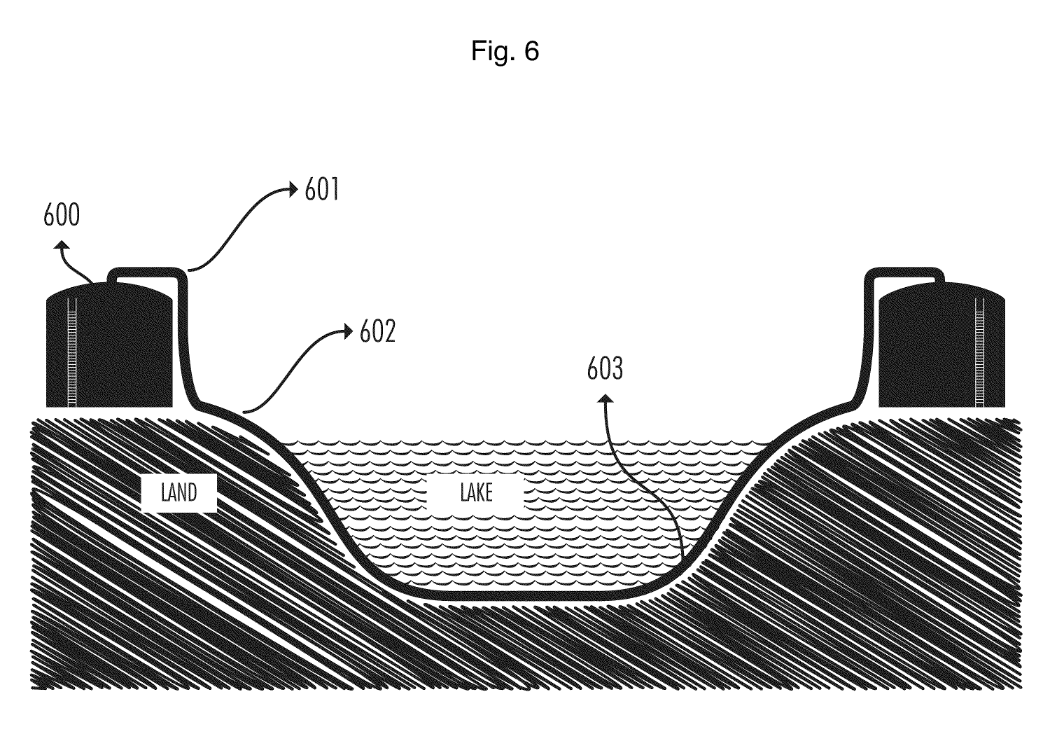

FIG. 6 is a diagram of the cased pipeline network crossing a large body of water or lake. The pipeline network 601, 602, and 603 is submerged along the lake bed and encloses a high number of interior pipelines for flowing gas or liquid products across the lake to pipeline network terminals 600. The terminals 600 provide for injection, delivery and accepting, pick-up, or outflow of gas or liquid products for transportation throughout the pipeline network. The terminals 600 may also be used for collecting leaked gas or liquid products that are contained and controlled by the outer casing or conduit pipeline or carrier pipelines.

The present invention provides an efficient method of building pipeline infrastructure through the development of a high number of pipelines as a single project. The outer casing, conduit pipeline, or carrier pipeline allows for a high number of pipelines to be developed simultaneously. This allows the pipeline developer to manage as a consolidated project, the permitting and approval process, route planning, engineering, surveying, and acquisition of right of ways, easements, and mineral rights. The pipeline network comprised of a high number of pipelines is developed inside the outer casing, conduit pipeline or carrier pipeline. Individual pipelines within the network may be leased or sold to different users or entities and be separately and diversely managed. For example, ownership of pipelines in the network may be transferred from the developer to investors, business entities, or other firms. Additionally, the management of pipelines within the network may be diversified and transferred to separate business entities or organizations.

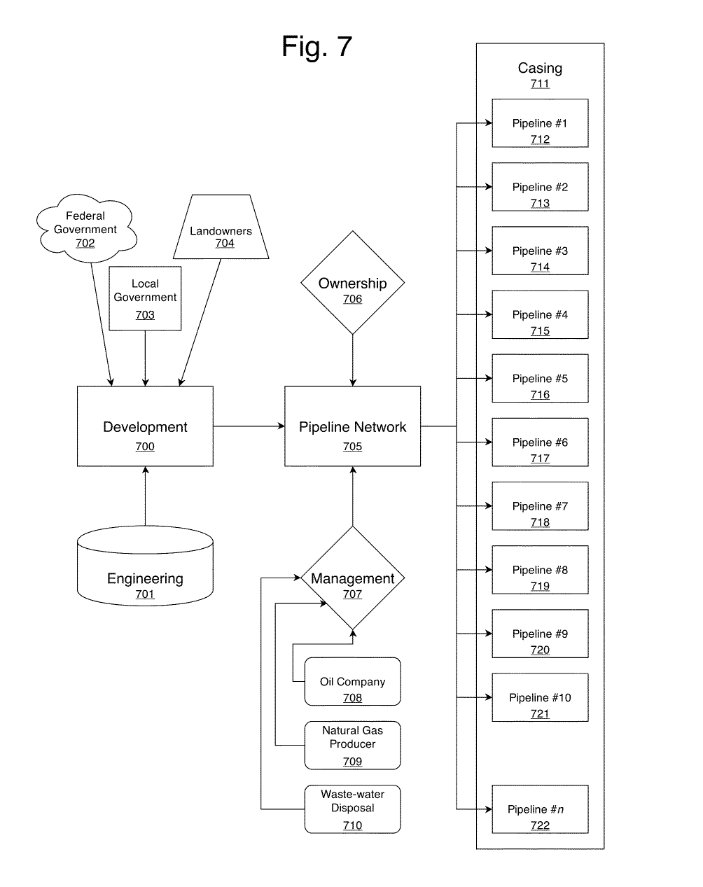

FIG. 7 is a flow diagram showing the development of the pipeline network with a high number of pipelines as a single consolidated project. The development 700 of the Pipeline Network 705 is a complex process, including but not limited too, collaboration with Engineering 701, permitting and approval of applications with the Federal Government 702 and Local Government 703, as well as the acquiring of easements and right-of-ways from Landowners 704. The developer of the pipeline network may divest Ownership 706 of the project to other business entities by leasing or selling individual Pipelines 712-722 in the network. Management 707 of the pipeline network may be diversified among separate business entities such as an Oil Company 708, Natural Gas Producer 709 or Waste-water Disposal contractor 710. These diverse business entities may separately manage individual Pipelines 712, 713, 714, 715, 716, 717, 718, 719, 720, 721, 722 which are enclosed by an outer Casing 711 for leakage containment and control. FIG. 7 shows ten (10) pipelines or line pipes in the network numbered as Pipeline #1-10, however the network may comprise different numbers of interior pipelines or n number of pipelines, i.e., Pipeline #n 722, enclosed by an outer Casing 711 or conduit pipeline or carrier pipeline.

In an embodiment of the present invention, an energy company may lease a pipeline or multiple pipelines in the network for dedicated crude oil transportation. For example, the Oil Company 708 may lease from the developer Pipeline #1 712 and Pipeline #2 713. At the pipeline network terminals, the crude oil carrying pipelines may be diverted to a specialized crude oil connection terminal for use by the energy company. The terminal area may include infrastructure for tank trucks, rail cars, or other pipeline transportation methods for crude oil. Pumps, valves and storage tanks may be provided for controlling and separately managing crude oil.

In another embodiment of the invention, a waste-water disposal contractor may buy a pipeline in the pipeline network for hydraulic fracturing waste-water transportation and disposal. For example, the Waste-water Disposal contractor 710 may buy Pipeline #4 715. At the pipeline network terminals, the contractor may connect and pump waste-water into Pipeline #4 715 and transport along the pipeline route. The contractor may bill customers per gallon with a volumetric metering system installed at the pipeline terminals. The pipeline network provides a safer method of transporting highly-corrosive saltwater. Leaks from corrosion are contained within the pipeline network outer casing.

In another embodiment of the invention, a natural gas producer may separately manage a pipeline in the network to transport natural gas from production well heads to storage facilities. For example, the Natural Gas Producer 709 may manage Pipeline #8 719, Pipeline #9 720 and Pipeline #10 721. The natural gas producer may connect Pipelines #8, #9 and #10 in the network with additional outside pipeline infrastructure or transportation methods. The excess natural gas produced at well heads is captured with the pipeline network and transported to underground storage reservoirs or above-ground liquefied natural gas tanks. The infrastructure provided by the pipeline network helps to reduce wasteful natural gas flaring.

1. A cased pipeline network for transportation and leakage containment of gas or liquid products, the pipeline network comprising:
a high number of interior pipelines enclosed within an outer casing for containing and flowing leaked gas or liquid products through the pipeline network; and
a collection point at pipeline network terminals for leaked gas or liquid products.

2. The pipeline network of claim 1, wherein the casing protects gas or liquid products from escaping into the environment.

3. The pipeline network of claim 1, wherein the outer casing is a conduit or carrier pipe and flows leaked gas or liquid product away from sensitive land areas or bodies of water by pumps, valves, or gravity flow designed for specific geographic location.

4. The pipeline network of claim 1, wherein the pipelines are supported and arranged inside the casing by a circular steel spacer with circular holes lined with ball bearings or rollers for supporting and arranging the interior pipelines.

5. The pipeline network of claim 1, wherein the network comprises one or more underwater conduits or carrier pipes arranged in parallel to traverse a body of water.

6. The pipeline network of claim 1, wherein the network is routed with consideration for flowing leaked gas or liquid product away from sensitive land areas or bodies of water.

7. A cased pipeline network method for transportation and leakage containment of gas or liquid products, the pipeline network method comprising:
enclosing a high number of pipelines within an outer casing;
containing leaked gas or liquid products from the pipelines within the casing; and
flowing the leaked gas or liquid products within the casing to pipeline network terminals for collection.

8. The pipeline network method of claim 7, wherein leaked gas or liquid products are prevented from escaping into the environment.

9. The pipeline network method of claim 7, wherein the outer casing is a conduit or carrier pipe and flows leaked gas or liquid product away from sensitive land areas or bodies of water by pumps, valves, or gravity flow designed for specific geographic location.

10. The pipeline network method of claim 7, wherein the pipelines are supported and arranged inside the casing by a circular steel spacer with circular holes lined with ball bearings or rollers for supporting and arranging the interior pipelines.

11. The pipeline network method of claim 7, wherein the network comprises one or more underwater conduits arranged in parallel to cross a body of water.

12. The pipeline network method of claim 7, wherein the network is routed with consideration for flowing leaked gas or liquid product away from sensitive land areas or bodies of water.

13. The pipeline network method of claim 7, wherein the network transports oil, natural gas, carbon dioxide, saltwater, or waste-water products.

14. A cased pipeline network method for transportation of gas or liquid products, the pipeline network method comprising:
enclosing a high number of pipelines within an outer casing for leakage containment and control;
developing the pipeline network as a single project to simplify and consolidate the permitting and approval process; and
separately managing, leasing, or selling the pipelines to diversified business entities.

15. The pipeline network method of claim 14, wherein the casing prevents gas or liquid products from escaping into the environment.

16. The pipeline network method of claim 14, wherein the outer casing is a conduit or carrier pipe and flows leaked gas or liquid product away from sensitive land areas or bodies of water.

17. The pipeline network method of claim 14, wherein the pipelines are supported and arranged inside the casing by a circular steel spacer with circular holes lined with ball bearings or rollers for supporting and arranging the interior pipelines.

18. The pipeline network method of claim 14, wherein the network comprises one or more underwater conduits arranged in parallel to cross a body of water.

19. The pipeline network method of claim 14, wherein the network is assembled on land, floated across water, and submerged into place.

20. The pipeline network method of claim 14, wherein the network transports oil, natural gas, carbon dioxide, saltwater, or waste-water products.
